(19) United States
(12) Patent Application Publication
(10) Pub. No.: US 2005/0272488 A1
(43) Pub. Date: Dec. 8, 2005

(54) Mobile telephone with rotatable keypad

(75) Inventor: Zhi-Gang Zou, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: FIH CO., LTD, Shindian City (TW)

(21) Appl. No.: 11/135,674

(22) Filed: May 24, 2005

(30) Foreign Application Priority Data
Jun. 4, 2004 (TW) 93208880

(51) Int. Cl. H04B 1/08

(52) U.S. Cl. 455/575.4; 455/351

(57) ABSTRACT

A mobile telephone includes a main body (20) and a keypad (30). The keypad is mounted on the main body. The keypad is rotatable relative to an axis that is substantially perpendicular to the main body. The main body and the keypad are interconnected by means of a shaft (322) that is arranged along the axis. The keypad includes a spring-loaded ball (326) that is spaced apart from the shaft a distance. The main body defines a segmentary rounded guiding shallow groove (25) receiving a portion of the ball. The keypad is movable between a first position where the ball is located in a first end of the guiding groove and a second position where the ball is located in a second opposite end of the guiding groove.

### FIELD OF THE INVENTION

The present invention relates to mobile telephones, and particularly to a mobile telephone with a rotatable keypad.

### BACKGROUND

As the technology of mobile telephones advances, various application software is being incorporated into them, such as on-line game software. In fact, on-line game software is now considered by some as being the most popular and indispensable feature available for mobile telephones. Network game development companies are continually introducing various new on-line network games in prolific quantities, and these network games now occupy a significant market position. In addition, the plethora of available on-line games is attracting an increasing number of users.

Accordingly, more and more mobile telephones are equipped with game playing functions. Many currently available mobile telephones have pre-installed game software, and are capable of downloading new games from the Internet.

As one example in the art, Nokia Corporation produces a game mobile telephone known as N-Gage. The shape of N-Gage is substantially quadrate. A screen is arranged in a middle of a main body of the mobile telephone. A split keypad is arranged on two sides of the screen. However, the size of the mobile telephone is unduly large. In addition, it can be uncomfortable to hold when phoning.

As another example in the art, Sony Ericsson Corporation provides a game mobile telephone marketed under the model number Z608. The mobile telephone has a complementary game board for playing games. When a user wants to play games, it is necessary to connect the game board to the mobile telephone via a connector. However, the game board is inconvenient to carry. In addition, repeated connecting and disconnecting of the connector may eventually damage the connector and adversely affects the operation of playing games.

What is needed, therefore, is a mobile telephone on which games can be conveniently played.

### SUMMARY

A mobile telephone of a preferred embodiment includes a main body and a keypad. The keypad is mounted on the main body. The keypad is rotatable relative to an axis that is substantially perpendicular to the main body. The main body and the keypad are interconnected by means of a shaft that is arranged along the axis. The keypad includes a spring-loaded ball that is spaced apart from the shaft a distance. The main body defines a segmentary rounded guiding shallow groove receiving a portion of the ball. The keypad is movable between a first position where the ball is located in a first end of the guiding groove and a second position where the ball is located in a second opposite end of the guiding groove.

The keypad is rotatably mounted on the main body. Therefore, the keypad can be operated breadthwise or lengthwise as desired. The operability and convenience of the mobile telephone are thus improved.

Other objects, advantages and novel features will become more apparent from the following detailed description of preferred embodiments when taken in conjunction with the accompanying drawings, in which:

### BRIEF DESCRIPTION OF THE DRAWINGS

FIG. 1 is an isometric view of a mobile telephone according to a preferred embodiment of the present invention, showing a keypad of the mobile telephone in a first position;

FIG. 2 is similar to FIG. 1, but showing the keypad in a second position;

FIG. 3 is an inverted, isometric view of the keypad, showing a bottom surface of the keypad;

FIG. 4 is a cross-sectional view taken along line IV-IV of FIG. 3;

FIG. 5 is an isometric view of an upper housing of a main body of the mobile telephone of FIG. 1, showing an upper surface of the upper housing; and

FIG. 6 is a cross-sectional view taken along line VI-VI of FIG. 5.

### DETAILED DESCRIPTION OF THE EMBODIMENTS

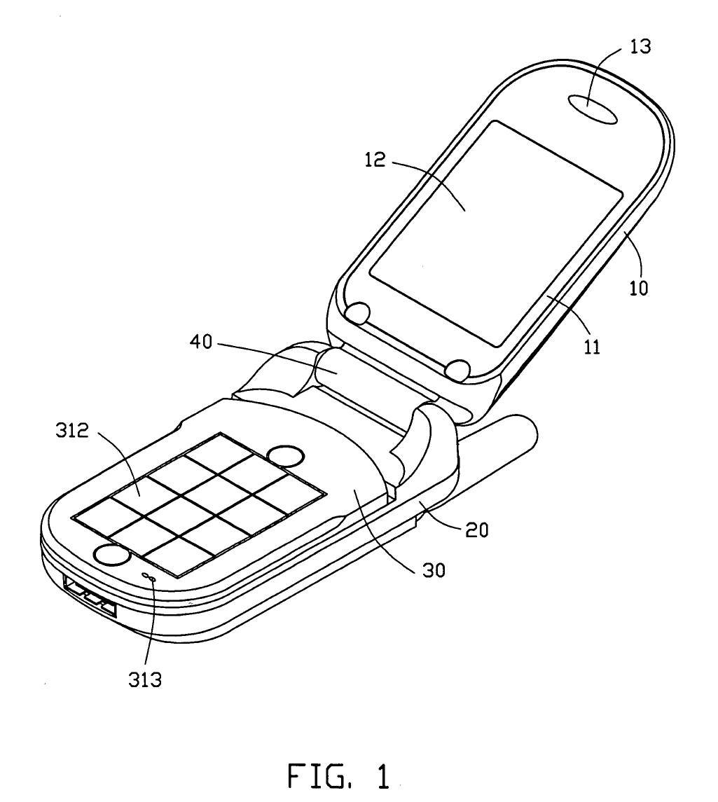

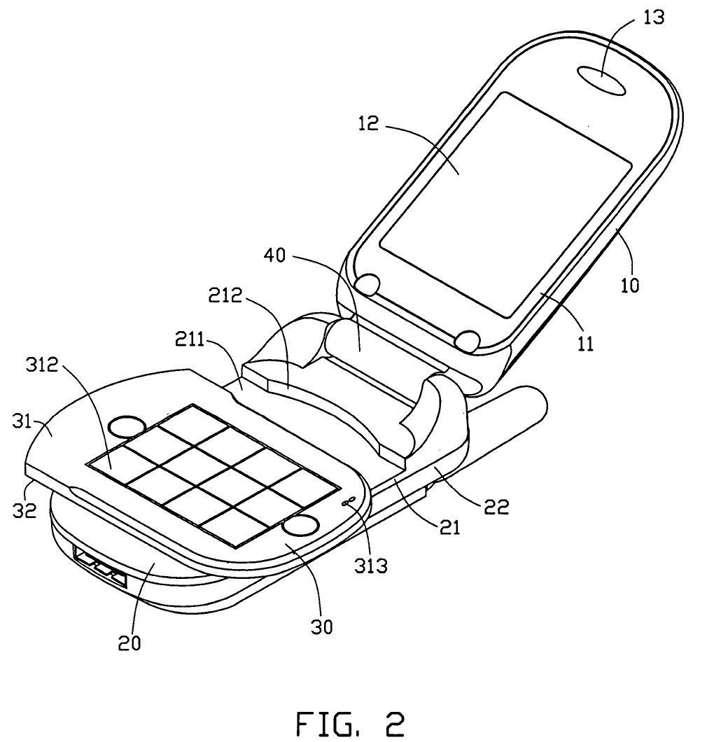

Referring to FIG. 1 and FIG. 2, a mobile telephone according to a preferred embodiment of the present invention includes a cover 10, a main body 20, a keypad 30 and a hinge 40. The cover 10 and the main body 20 are coupled together by means of the hinge 40. The keypad 30 is rotatably mounted on the main body 20 relative to an axis that is perpendicular to the main body 20. The keypad 30 is movable between a first position (see FIG. 1) and a second position (see FIG. 2).

A display screen 12 is arranged on an inner surface 11 of the cover 10 for displaying information. A speaker 13 is arranged in the cover 10 adjacent the display screen 12.

The main body 20 includes an upper housing 21 and a lower housing 22. The upper housing 21 and the lower housing 22 cooperatively form a space for receiving a circuit board (not shown), a battery (not shown) and electronic elements (not shown) therein. A recessed portion 211 is defined in the upper housing 21 for receiving the keypad 30. A mating edge 212 of the recessed portion 211 is shaped according to a contour of the keypad 30, for allowing the keypad 30 to rotate smoothly.

The keypad 30 is generally rectangular. In the illustrated embodiment, the keypad 30 is movable between a first position where the keypad 30 is lengthwise oriented (see FIG. 1) and a second position where the keypad 30 is breadthwise oriented (see FIG. 2). The keypad 30 has an upper surface 31 and a lower surface 32. The keypad 30 has a plurality of keys 312 arranged on the upper surface 31. A mouthpiece microphone 313 is arranged adjacent the keys 312. Depending on different requirements, the keypad 30 may be a QWERTY keyboard or a numeric keypad. The keys 312 of the keypad 30 may be capable of switching functionality between when the keypad 30 is in the first position and when the keypad 30 is in the second position, which can be accomplished with the aid of particular hardware and/or software.

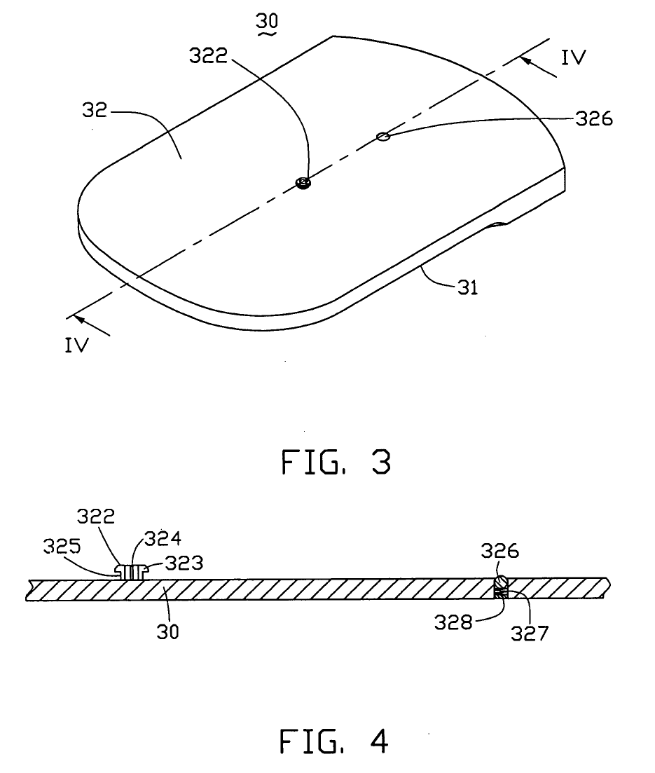

Referring to FIG. 3 and FIG. 4, a shaft 322 is perpendicularly arranged on a center of the bottom surface 32 of the keypad 30. The shaft 322 has a first end fixed to the bottom surface 32, a shaft portion 325 extending from the bottom surface 32, and a rounded latching protuberance 323 formed on a second distal end. The latching protuberance 323 is elastically deformable. A through hole 324 is defined in the shaft 322 for extension of a flexible cable (not shown) therethrough, which is utilized to establish an electrical connection between the circuit board and the keypad 30. The mobile telephone includes a stop mechanism. In the illustrated embodiment, the stop mechanism includes a spring-loaded ball 326, a spring 328, and a guiding groove 25 defined in the main body 20, which will be described in detail below. One end of the spring 328 is fixed to the ball 326. The other end of the spring 328 is fixed in a hole 327 which is defined in the bottom surface 32, and is spaced apart from the shaft 322 a predetermined distance. The ball 326 is partially exposed beyond the bottom surface 32.

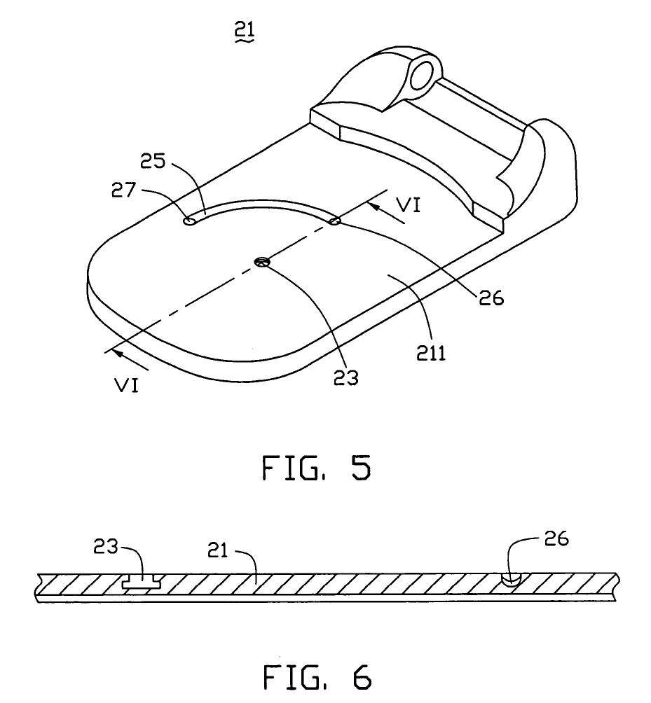

Referring to FIG. 5 and FIG. 6, a mounting hole 23 is defined in a center of the recessed portion 211 of the upper housing 21, for retainably receiving the latching protuberance 323 of the shaft 322. The shape of the mounting hole 23 corresponds to the shape of the latching protuberance 323 of the shaft 322. The latching protuberance 323 of the shaft 322 is deformably retained in the mounting hole 23. Therefore, the keypad 30 is rotatably mounted to the main body 20. The guiding groove 25 is defined in the upper housing 21 for receiving a portion of the ball 326. The guiding groove 25 is a segmentary rounded guiding shallow groove defined relative to the mounting hole 23. The ball 326 is slidable along the guiding groove 25, for limiting the keypad 30 to rotate in the range from 0° to approximate 90°. A first positioning dent 26 is defined at a first end of the guiding groove 25, for snappingly retaining the ball 326 in a first position where the keypad 30 is positioned in the first position. A second positioning dent 27 is defined at a second opposite end of the guiding groove 25, for snappingly retaining the ball 326 in a second position where the keypad 30 is positioned in the second position. The first and second positioning dents 26, 27 are a little deeper than the sliding slot 25.

In assembly, with the deformation of the latching protuberance 323 of the shaft 322, the latching protuberance 323 is pressed into the mounting hole 23. As a result, the shaft 322 is latchingly engaged in the mounting hole 23. With the engagement of the shaft 322 and the mounting hole 23, the keypad 30 is rotatable relative to an axis defined along the shaft 322 and being perpendicular to a main plane of the main body 20.

In use, when the mobile telephone is in a standby state, the cover 10 is folded on the main body 20. The ball 326 is engaged in the first positioning dent 26 for positioning the keypad 30 in the first position. When phoning, the cover 10 is unfolded from the main body 20 (see FIG. 1). If a game is to be played, the keypad 30 is rotated at the angle of approximately 90° along the anticlockwise direction, such that the keypad 30 is in the second position. In this process, the ball 326 is disengaged from the first positioning dent 26 under the application of external force. Subsequently, the ball 326 slides along the sliding slot 25, until the ball 326 is engaged in the second positioning dent 27. The keypad 30 is thus held in the second position (see FIG. 2). Because the keypad 30 is arranged breadthwise relative to the display 12, it is convenient for a user to operate the keypad 30 with two hands when performing activities such as playing games or inputting information. Therefore, the operability of the mobile telephone is greatly improved.

In another embodiment, a mobile telephone (not shown) does not include the cover 10 and the hinge 40. The display 12 and speaker 13 are provided on the main body 20. The keypad 30 is rotatably mounted on the main body 20 below the display 12. The interconnection between the main body 20 and the keypad 30 is similar to the above-described preferred embodiment.

In addition, there are other suitable interconnection methods between the keypad 30 and the main body 20. For instance, the shaft 322 can be arranged on the upper housing 21 of the main body 20. Correspondingly, the mounting groove 23 is defined in the bottom surface 32 of the keypad 30. Likewise, the ball 326 can be arranged on the upper housing 21 of the main body 20. Correspondingly, the guiding groove 25 is defined in the bottom surface 32 of the keypad 30. Understandably, the guiding groove 25 and the spring-loaded ball 326 are not an indispensable configuration and may be omitted.

Furthermore, the guiding groove 25 can also be a closed loop. To satisfy different requirements, one or more positioning dents can be further arranged in the sliding slot 25 so that the keypad 30 can be oriented at different positions. The spring-loaded ball 326 can also be substituted with an elastic protrusion.

It is to be further understood that even though numerous characteristics and advantages of the embodiments have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

1. A mobile telephone comprising:
a main body; and
a keypad mounted on the main body, the keypad being rotatable relative to an axis that is substantially perpendicular to the main body.

2. The mobile telephone as claimed in claim 1, wherein the main body and the keypad are interconnected by means of a shaft that is arranged along the axis.

3. The mobile telephone as claimed in claim 2, wherein a through hole is defined in the shaft, for extension of a flexible cable therethrough and establishing of an electrical connection between the main body and the keypad.

4. The mobile telephone as claimed in claim 2, wherein a recessed portion is defined on the main body for receiving the keypad therein.

5. The mobile telephone as claimed in claim 4, wherein the shaft comprises a first end fixedly coupled to a center area of the keypad, and a second opposite end engageably coupled to a center area of the recessed portion.

6. The mobile telephone as claimed in claim 5, wherein the second opposite end of the shaft is shaped as a deformable protuberance, the recessed portion defines a mounting hole in the center area thereof, and the keypad is secured to the main body by engaging the protuberance of the shaft in the mounting hole.

7. The mobile telephone as claimed in claim 1, wherein the keypad comprises a spring-loaded ball spaced apart from the axis a distance, the main body defines a segmentary rounded guiding shallow groove receiving a portion of the ball, and the keypad is rotatable between a first position where the ball is located in a first end of the guiding groove and a second position where the ball is located in a second opposite end of the guiding groove.

8. The mobile telephone as claimed in claim 7, wherein the keypad is rotatable relative to the main body in the range from 0° to approximate 90°.

9. The mobile telephone as claimed in claim 7, wherein first and second positioning deep dents are defined in the first and second ends of the guiding shallow groove, respectively, for snappingly retaining the ball in position.

10. The mobile telephone as claimed in claim 7, wherein the keypad comprises a plurality of keys arranged thereon, and at least one of the keys has different functionality between when the keypad is in the first position and when the keypad is in the second position.

11. The mobile telephone as claimed in claim 4, wherein the shaft comprises a first end fixedly coupled to a center area of the recessed portion, and a second opposite end engageably coupled to a center area of the keypad.

12. The mobile telephone as claimed in claim 1, wherein the keypad is a QWERTY keyboard.

13. The mobile telephone as claimed in claim 1, wherein the keypad is a numeric keypad.

14. A mobile telephone comprising:
a main body;
a keypad rotatably mounted on the main body; and
a through hole is defined in the main body, for extension of a flexible cable therethrough and establishing of an electrical connection between the main body and the keypad.

15. The mobile telephone as claimed in claim 14, wherein the keypad comprises a spring-loaded ball, the main body defines a segmentary rounded guiding shallow groove receiving a portion of the ball, first and second positioning deep dents are defined in the first and second ends of the guiding shallow groove, respectively, for snappingly retaining the ball in position, and the keypad is rotatable between a first position where the ball is located in the first positioning deep dent and a second position where the ball is located in the second positioning deep dent.

16. A mobile telephone comprising:
a main body, defining first and second positioning dents; and
a keypad, comprising a spring-loaded ball;
wherein the keypad is rotatable between a first position where the ball is located in the first positioning dent and a second position where the ball is located in the second positioning dent.

17. The mobile telephone as claimed in claim 16, wherein the main body defines a segmentary rounded guiding groove receiving a portion of the ball, the first and second positioning dents are defined in the first and second ends of the guiding shallow groove, respectively, for snappingly retaining the ball in position.
